(19) United States
(12) Patent Application Publication
(10) Pub. No.: US 2008/0152461 A1
(43) Pub. Date: Jun. 26, 2008

(54) System and Method for Fastener with Grooved Body

(76) Inventor: Gerald A. Dente, Natick, MA (US)

Correspondence Address: HAYES, SOLOWAY P.C., 175 CANAL STREET, MANCHESTER, NH, 03101, US

(21) Appl. No.: 11/615,075

(22) Filed: Dec. 22, 2006

(51) Int. Cl. F16B 35/04

(52) U.S. Cl. 411/413

(57) ABSTRACT

The system contains a rod body having a first end and a second end. A conical section is integral with the rod body at the first end of the rod body. The conical section tapers off at a triangular tip section. The triangular tip section has a proximate end integral with the conical section and a substantially pointed distal end. A higher helical rib is formed on the rod body and the conical section. A lower helical rib is integral with the higher helical rib at a first rib end. The lower helical rib extends onto the conical section and tapers toward the substantially pointed distal end. A partial groove is formed in the conical section along a proximate side of the lower helical rib. The groove does not extend entirely between adjacent lower helical rib elements. A gripping portion is proximate to the second end of the rod body.

### FIELD OF THE INVENTION

The present invention is generally related to a fastener and, more particularly, is related to a screw having a shaped portion between helical ribs.

### BACKGROUND OF THE INVENTION

FIG. 1 is a front view of a screw 10, in accordance with a prior art screw design. Getting a conventional screw 10 to bite into most traditional building materials like plywood, paneling, cement board, one-by's, two-by's, particleboard, composite wood, and so on can be difficult. Whether your hand turns a finish wood screw or install decking with a screw gun, every carpenter and DIY knows how aggravating it is when the screw 10 turns and turns, but nothing happens. The screw 10 does not bite and instead the unstable screw 10 falls to the side as you push down and the driver damages the work surface or a bracing hand. The problem lies in the screw tip, as every carpenter knows most screws 10 will not bite until the helical rib 12 of the screw 10 engages the surface of the material, which can require significant initial force.

Thus, a heretofore unaddressed need exists in the industry to address the aforementioned deficiencies and inadequacies.

### SUMMARY OF THE INVENTION

Embodiments of the present invention provide a system and method for providing a fastener. Briefly described, in architecture, one embodiment of the system, among others, can be implemented as follows. The system contains a rod body having a first end and a second end. A conical section is formed integral with the rod body at the first end of the rod body. The conical section tapers off at a triangular tip section. The triangular tip section has at least one flat side, a proximate end integral with the conical section, and a substantially pointed distal end, A notch is formed in an angular side of the triangular tip section. A higher helical rib is formed on the rod body and the conical section. A lower helical rib is formed integral with the higher helical rib at a first rib end. The lower helical rib extends onto the conical section and tapers toward a distal end of the notch. A gripping portion is integral with the rod body, proximate to the second end of the rod body.

Another embodiment of the system may be described as follows. The system contains a rod body having a first end and a second end. A conical section is integral with the rod body at the first end of the rod body. The conical section tapers off at a triangular tip section. The triangular tip section has a proximate end integral with the conical section and a substantially pointed distal end. A higher helical rib is formed on the rod body and the conical section. A lower helical rib is integral with the higher helical rib at a first rib end. The lower helical rib extends onto the conical section and tapers toward the substantially pointed distal end. A partial groove is formed in the conical section along a proximate side of the lower helical rib. The groove does not extend entirely between adjacent lower helical rib elements. A gripping portion is proximate to the second end of the rod body.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a front view of a fastener tip, in accordance with a prior art screw tip design.

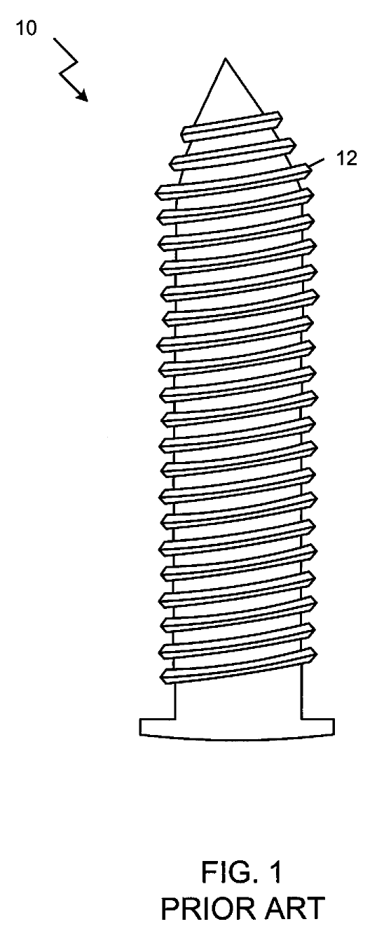

FIG. 2 is a prospective view of a fastener, in accordance with a first exemplary embodiment of the present invention.

FIG. 3 is a front view of a portion of the fastener illustrated in FIG. 2, in accordance with the first exemplary embodiment of the present invention.

FIG. 4 is a side view of the portion of the fastener illustrated in FIG. 3, in accordance with the first exemplary embodiment of the present invention.

FIG. 5 is a front view of a portion of a fastener, in accordance with a second exemplary embodiment of the present invention.

FIG. 6 is a side view of the portion of the fastener illustrated in FIG. 5, in accordance with the second exemplary embodiment of the present invention.

FIG. 7 is a side view of the portion of the fastener illustrated in FIG. 5, in accordance with the second exemplary embodiment of the present invention, attaching an object to a wall.

FIG. 8 is a front view of a portion of the fastener, in accordance with a third exemplary embodiment of the present invention.

FIG. 9 is a side view of the portion of the fastener illustrated in FIG. 8, in accordance with the third exemplary embodiment of the present invention.

### DETAILED DESCRIPTION

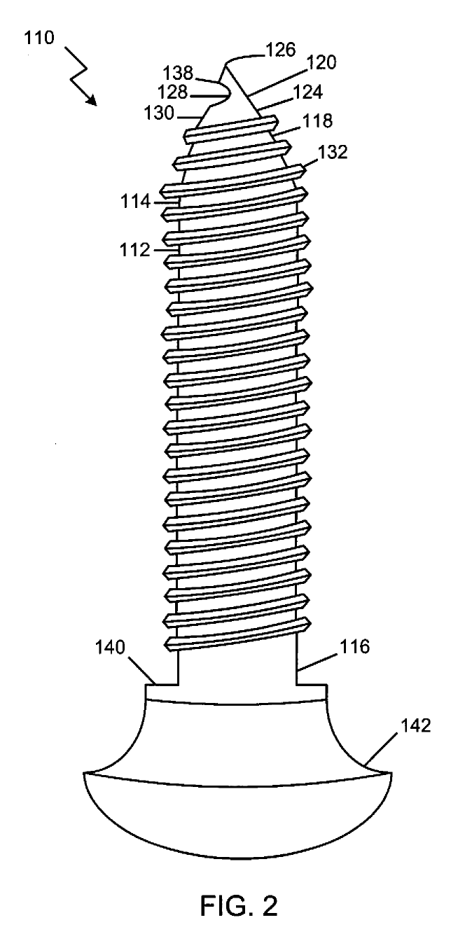

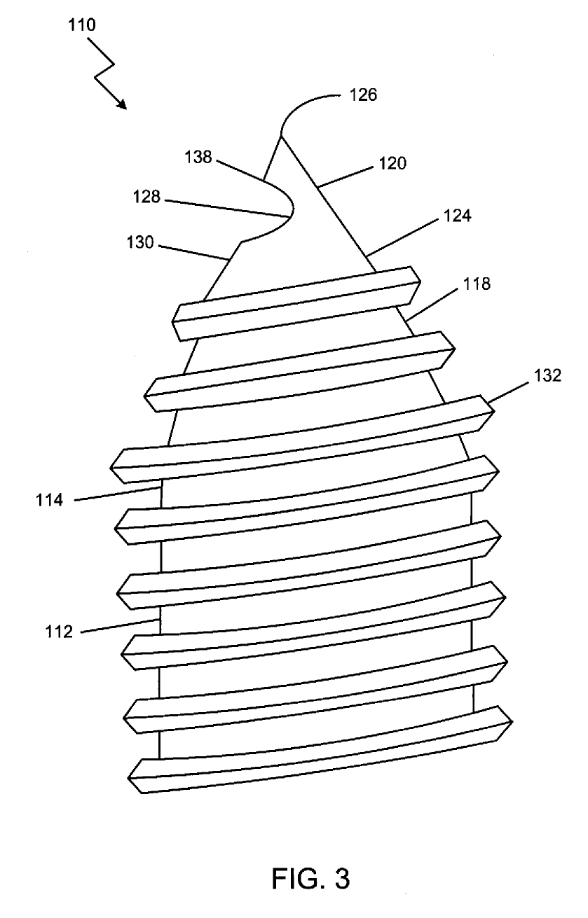

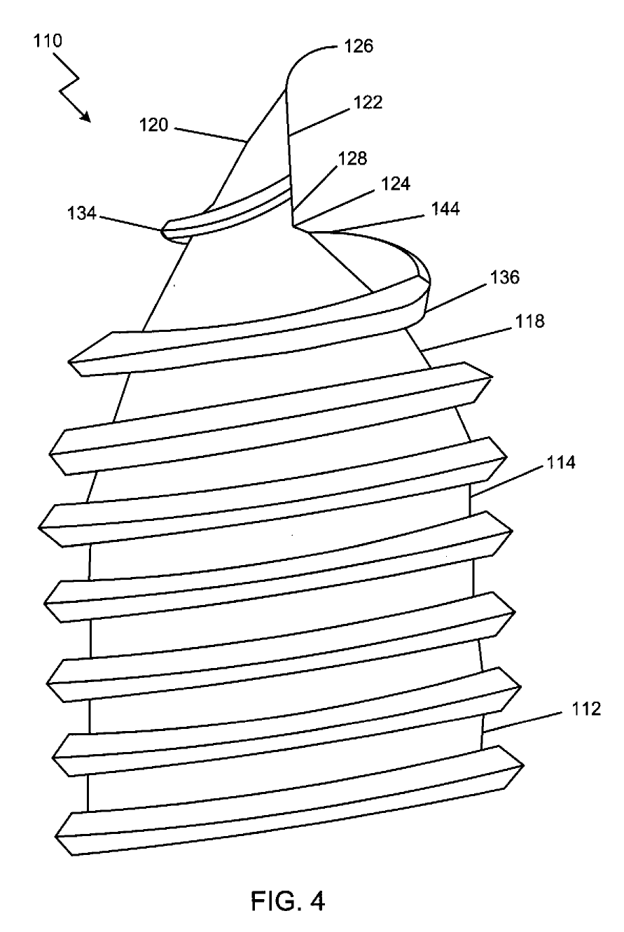

FIG. 2 is a prospective view of a fastener 110, in accordance with a first exemplary embodiment of the present invention. FIG. 3 is a front view of a portion of the fastener 110 illustrated in FIG. 2, in accordance with the first exemplary embodiment of the present invention. FIG. 4 is a side view of the portion of the fastener 110 illustrated in FIG. 3, in accordance with the first exemplary embodiment of the present invention. The fastener 110 contains a rod body 112 having a first end 114 and a second end 116. A conical section 118 is formed integral with the rod body 112 at the first end 114 of the rod body 112. The conical section 118 tapers off at a triangular tip section 120. The triangular tip section 120 has at least one flat side 122, a proximate end 124 integral with the conical section 118, and a substantially pointed distal end 126. A notch 128 is formed in an angular side 130 of the triangular tip section 120. A higher helical rib 132 is formed on the rod body 112 and the conical section 118. A lower helical rib 134 is formed integral with the higher helical rib 132 at a first rib end 136. The lower helical rib 134 extends onto the conical section 118 and tapers toward a distal end 138 of the notch 128. A gripping portion 140 is integral with the rod body 112, proximate to the second end 116 of the rod body 112.

As can be seen in FIG. 2, the gripping portion 140 may be a handle 142. The handle 142 may be twisted to allow the fastener 110 to penetrate a surface. In alternative designs, the gripping portion 140 may be, for instance, a slot, mateable with a flat head screwdriver, a plus-shaped groove, mateable with a Philips™ head screwdriver, a hexagonal indentation formed therein, such as for an Allen wrench, or a similar feature known to other screw designs. The gripping portion 140 may also be a hook, which can be used for twisting the fastener 110 to penetrate a surface and for hanging items, in a traditional hook function, once the fastener 110 is secured. Other designs for the gripping portion 140 are conceivable and would be known to those having ordinary skill in the art and, as such, are considered to be within the scope of the present invention.

As can be seen in FIG. 4, the triangular tip section 120 has a narrow profile. This profile is narrow, in part, because of the flat side 122. The narrow profile allows the fastener 110 to achieve initial penetration of a surface more easily when using the fastener 110. The flat side 122 may continue from the pointed distal end 126 down past the notch 128. The length of the flat side 122 may permit the lower helical rib 134 toward the distal end 138 of the notch 128 to be included in initial penetration of the surface. Once the lower helical rib 134 penetrates the surface, the fastener 110 can be expected to have some bite as it continues to penetrate the surface.

The flat side 122 would normally be expected to provide some resistance to the act of twisting the fastener 110 and, possibly, cause splitting in the surface. As can be seen in FIG. 3, the notch 128 reduces the area of the left portion of the flat side 122. When twisting the fastener 110 in a clockwise direction, it is this left portion that would provide resistance. By forming the notch 128, a significant portion of that resistance is prevented.

The flat side 122 extends from the substantially pointed distal end 126 to above a top portion 144 of the lower helical rib 134. In this regard, the flat side 122 does not interfere with the lower helical rib 134 as it extends along a first revolution along the conical section 118. While the flat side 122 appears to be formed by removing approximately half of the triangular tip section 120 in FIG. 4, various fractions of the triangular tip section 120 may be removed to create the flat side 122, without departing from the scope of the present invention.

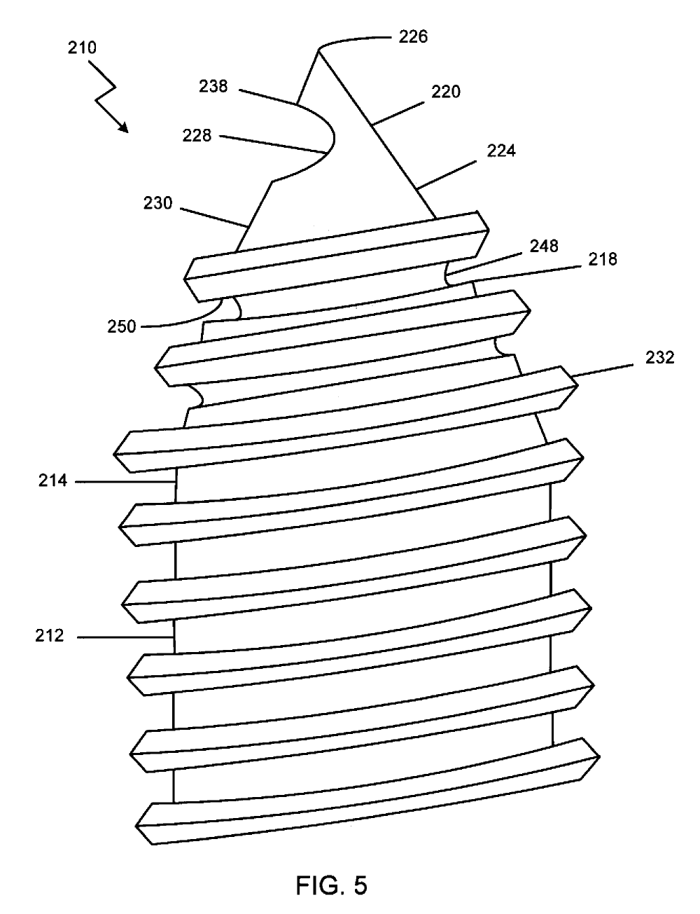

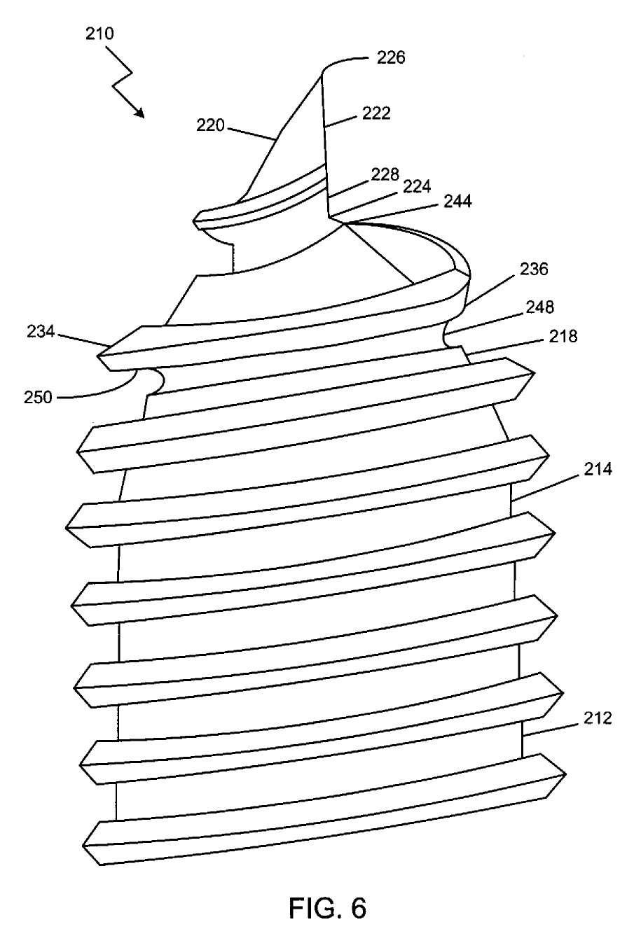

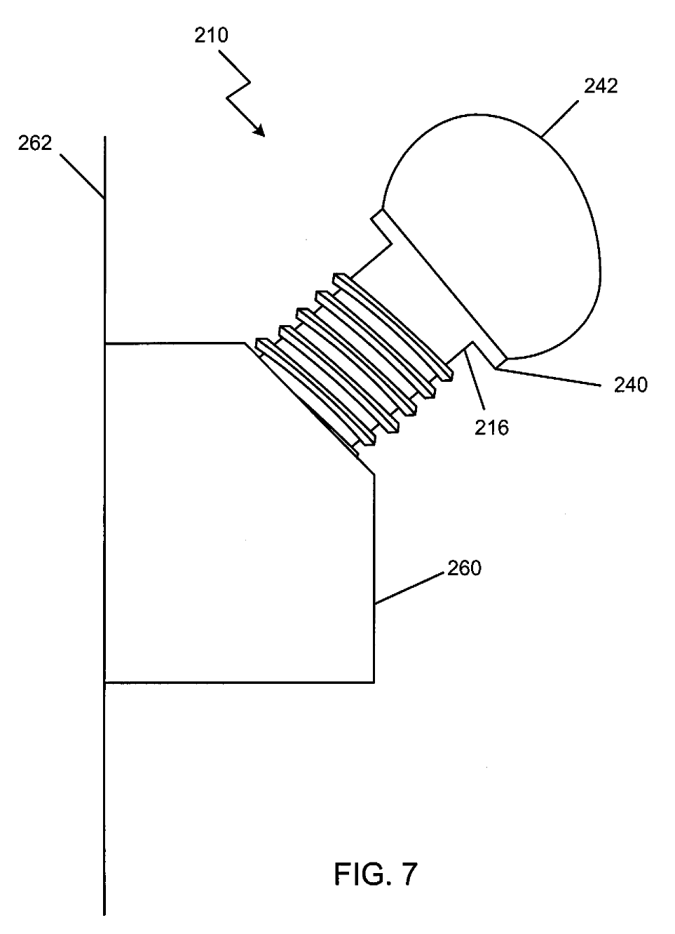

FIG. 5 is a front view of a portion of a fastener 210, in accordance with a second exemplary embodiment of the present invention. FIG. 6 is a side view of the portion of the fastener 210 illustrated in FIG. 5, in accordance with the second exemplary embodiment of the present invention. The fastener 210 contains a rod body 212 having a first end 214 and a second end 216 (shown in FIG. 7). A conical section 218 is formed integral with the rod body 212 at the first end 214 of the rod body 212. The conical section 218 tapers off at a triangular tip section 220. The triangular tip section 220 has at least one flat side 222, a proximate end 224 integral with the conical section 218, and a substantially pointed distal end 226. A notch 228 is formed in an angular side 230 of the triangular tip section 220. A higher helical rib 232 is formed on the rod body 212 and the conical section 218. A lower helical rib 234 is formed integral with the higher helical rib 232 at a first rib end 236. The lower helical rib 234 extends onto the conical section 218 and tapers toward a distal end 238 of the notch 228. A gripping portion 240 is integral with the rod body 212, proximate to the second end 216 of the rod body 212.

As can be seen in FIG. 5 and FIG. 6, a partial groove 248 is formed in the conical section 218 along a proximate end 250 of the lower helical rib 234, wherein the groove 248 does not extend entirely between adjacent lower helical rib 234 elements. The partial groove 248 may be an approximately 1/64^{th} inch channel cut into the conical section 218. The partial groove 248 may extend from the notch 228, beneath the lower helical rib 234, and continue to the proximate vicinity where the lower helical rib 234 meets the higher helical rib 232 on the rod body 212. The partial groove 248, as shown, may extend along approximately two rotations of the fastener 210. The partial groove 248 increases the surface area of the lower helical rib 234, which may operate to improve fastening strength of the fastener 210. The cross-sectional geography of the partial groove 248 may be similar to that of the notch 228. While the partial groove 248 is shown along a limited portion of the fastener 210, the partial groove 248 may extend along a greater or lesser portion of the fastener 210 without departing from the scope of the present invention.

The flat side 222 extends from the substantially pointed distal end 226 to above a top portion 244 of the lower helical rib 234. In this regard, the flat side 222 does not interfere with the lower helical rib 234 as it extends along a first revolution along the conical section 218. While the flat side 222 appears to be formed by removing approximately half of the triangular tip section 220 in FIG. 6, various fractions of the triangular tip section 220 may be removed to create the flat side 222, without departing from the scope of the present invention.

FIG. 7 is a side view of the portion of the fastener 210 illustrated in FIG. 5, in accordance with the second exemplary embodiment of the present invention, attaching an object 260 to a wall 262. The fastener 210 is attached at an angle, which can be difficult for other fasteners, but is practical in part because of the flat side 222 of the triangular tip section 220. The gripping portion 240 may be a decorative handle 242. The object 260 may be a wall bracket for hanging shelves, a shelf, or any other item that may be useful or desirable to mount on a wall.

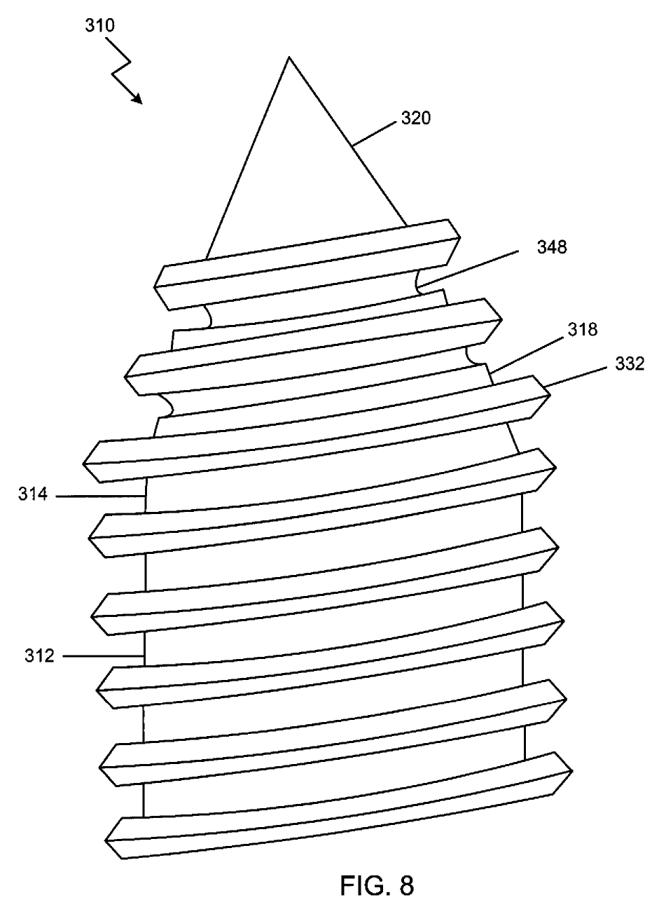

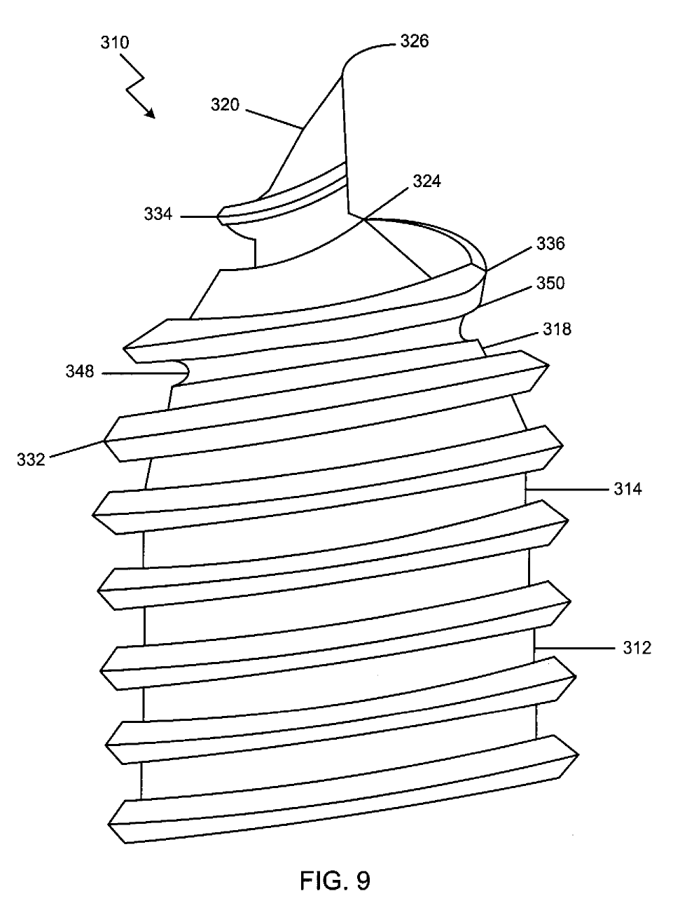

FIG. 8 is a front view of a portion of the fastener 310, in accordance with a third exemplary embodiment of the present invention. FIG. 9 is a side view of the portion of the fastener 310 illustrated in FIG. 8, in accordance with the third exemplary embodiment of the present invention. The fastener contains a rod body 312 having a first end 314 and a second end. A conical section 318 is formed integral with the rod body 312 at the first end 314 of the rod body 312. The conical section 318 tapers off at a triangular tip section 320. The triangular tip section 320 has a proximate end 324 integral with the conical section 318 and a substantially pointed distal end 326. A higher helical rib 332 is formed on the rod body 312 and the conical section 318. A lower helical rib 334 is formed integral with the higher helical rib 332 at a first rib end 336. The lower helical rib 334 extends onto the conical section 318 and tapers toward the substantially pointed distal end 326. A gripping portion is integral with the rod body 312, proximate to the second end 316 of the rod body 312.

As can be seen in FIG. 8 and FIG. 9, a partial groove 348 is formed in the conical section 318 along a proximate end 350 of the lower helical rib 334, wherein the groove 348 does not extend entirely between adjacent lower helical rib 334 elements. The partial groove 348 may be an approximately 1/64^{th} inch channel cut into the conical section 318. The partial groove 348 may extend from the substantially pointed distal end 326, beneath the lower helical rib 3341 and continue to the proximate vicinity where the lower helical rib 334 meets the higher helical rib 332 on the rod body 312. The partial groove 348, as shown, may extend along approximately two rotations of the fastener 310. The partial groove 348 increases the surface area of the lower helical rib 334, which may operate to improve fastening strength of the fastener 310.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A fastener comprising:
a rod body having a first end and a second end;
a conical section integral with the rod body at the first end of the rod body, the conical section tapering off at a triangular tip section;
the triangular tip section having at least one flat side, a proximate end integral with the conical section, and a substantially pointed distal end;
a notch formed in an angular side of the triangular tip section;
a higher helical rib formed on the rod body and the conical section;
a lower helical rib integral with the higher helical rib at a first rib end, the lower helical rib extending onto the conical section and tapering toward a distal end of the notch; and
a gripping portion proximate to the second end of the rod body.

2. The fastener of claim 1, wherein the gripping portion further comprises a handle.

3. The fastener of claim 1, wherein the gripping portion further comprises a flat head having one of the group consisting of a slot, a plus-shaped groove, and a hexagonal indentation formed therein.

4. The fastener of claim 1, further comprising a partial groove formed in the conical section along a proximate end of the lower helical rib, wherein the groove does not extend entirely between adjacent lower helical rib elements.

5. The fastener of claim 1, wherein the gripping portion further comprises a hook.

6. A fastener comprising:
a rod body having a first end and a second end;
a conical section integral with the rod body at the first end of the rod body, the conical section tapering off at a triangular tip section;
the triangular tip section having a proximate end integral with the conical section and a substantially pointed distal end;
a higher helical rib formed on the rod body and the conical section;
a lower helical rib integral with the higher helical rib at a first rib end, the lower helical rib extending onto the conical section and tapering toward the substantially pointed distal end;
a partial groove formed in the conical section along a proximate side of the lower helical rib, wherein the groove does not extend entirely between adjacent lower helical rib elements; and
a gripping portion proximate to the second end of the rod body.

7. The fastener of claim 6, further comprising a notch formed in the triangular tip section at a distal end of the partial groove.

8. The fastener of claim 6, further comprising a flat side formed in the triangular tip section extending from the substantially pointed distal end to the lower helical rib.

9. The fastener of claim 6, wherein the gripping portion further comprises a handle.
